(19) United States
(12) Patent Application Publication
(10) Pub. No.: US 2016/0183492 A1
(43) Pub. Date: Jun. 30, 2016

(54) PET WASTE SYSTEM WITH INTEGRATED PET WASTE BAG DISPENSER

(71) Applicants: Zachary Norman, Venice, CA (US); Natalie Youn, Venice, CA (US)

(72) Inventors: Zachary Norman, Venice, CA (US); Natalie Youn, Venice, CA (US)

(21) Appl. No.: 15/065,801

(22) Filed: Mar. 9, 2016

Related U.S. Application Data
(63) Continuation-in-part of application No. 14/678,676, filed on Apr. 3, 2015.
Application No. 14/678,676 is a continuation-in-part of application No. 14/446,242, filed on Jul. 29, 2014.

(51) Int. Cl. A01K 1/01; B65D 81/26; A01K 29/00

(52) U.S. Cl. CPC A01K 1/011; A01K 29/00; B65D 81/264

(57) ABSTRACT

A pet waste system having an integrated pet waste bag dispenser. A base of the pet waste system is provided with an opening to accommodate a roll of pet waste bags. The base and/or cover are also provided with another opening to allow a pet waste bag to be dispensed.

### CROSS-REFERENCE TO RELATED APPLICATION

This application is a continuation-in-part of U.S. patent application Ser. No. 14/678,676, filed Apr. 3, 2015, published as U.S. Patent Publication No. 2016/0029589, and also a continuation-in-part of U.S. patent application Ser. No. 14/446,242, filed Jul. 29, 2014, published as U.S. Patent Publication No. 2015/0196004, which claims priority to U.S. Provisional Application No. 61/927,473, filed Jan. 15, 2014, all of which are hereby incorporated by reference in their entireties as if fully recited herein.

### BACKGROUND OF THE INVENTION

1. Field of the Invention

The present invention generally relates to a pet waste system for use by household pets, such as dogs, for example. Pet owners have the responsibility of allowing the pet to relieve itself periodically. Oftentimes, the pet owner cannot let or take the pet outdoors, because the owner is simply not available to do so. Smaller pets, often found in apartments or generally smaller living spaces, need to relieve themselves more frequently, increasing the need for a convenient solution for them to relieve themselves as necessary.

2. Description of the Related Art

U.S. Pat. No. 8,522,719, which is incorporated herein entirety by reference, relates to a portable, fully-disposable, pet toilet whose cavity is fitted with living grass, living sod, or a grass-seed medium. It has a fitted, removable cover or fold-back lid to enable the shipping and disposal of the unit in its entirely. This pet toilet, however, has a number of drawbacks, which are addressed by the invention disclosed herein.

One notable issue is that while liquid waste may be absorbed, solid waste needs to be picked up and disposed of. As such, there is a need for easily accessible disposable bags to be available for use to in conjunction with the pet waste receptacle. The present invention addresses this issue, among others.

### BRIEF DESCRIPTION OF THE DRAWINGS

FIG. 1 illustrates an exemplary pet waste system with integrated pet waste bag dispenser in accordance with one embodiment of the present invention; and

FIG. 2 illustrates an exploded view of the exemplary pet waste system with integrated pet waste bag dispenser in accordance with one embodiment of the present invention.

### DETAILED DESCRIPTION OF THE DRAWINGS

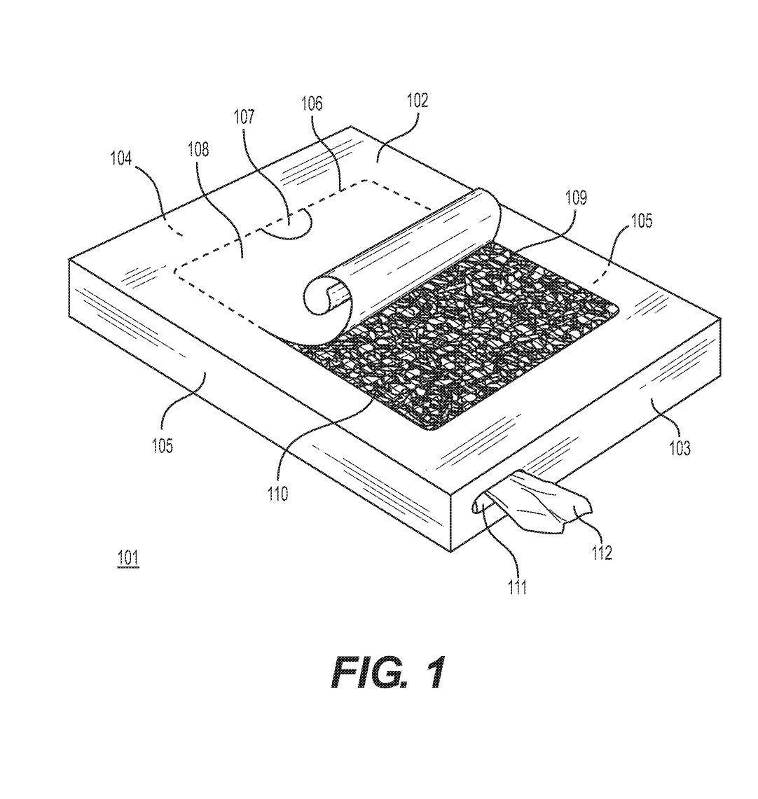

FIG. 1 illustrates a pet waste system with integrated pet waste bag dispenser 101 in accordance with one embodiment of the present invention. Pet waste system 101 has a cover or lid 102 and base (not visible in FIG. 1).

Cover or lid 102 has a front wall 103, rear wall 104 and opposing sidewalls 105. The base also has a front wall, rear wall and opposing sidewalls to mate with each wall of the cover or lid 102. The cover or lid 102 can have a perforated edge 106 and a tab 107 to allow for removal of a portion 108 of the cover or lid 102 to expose the contents inside of the system 101.

Base generally holds litter 109 or other absorbent material. Litter 109 can be a variety of organic and inorganic materials, including, but not limited to, cellulose, plant fiber, wood chips, wood filings, bark, bark chips, wood shavings, moss, lichen, mulch, straw, potpourri, hay, dried grass, sawdust, wood pellets, sponge, sand, wildflower, any non-living grass or plant material such as peat, moss, fodder, for example. Various combinations of these materials are also possible. These are examples and any other substance that may absorb fluid and/or odor are well within the scope of the invention.

Netting 110 can be provided over litter 109 to hold litter 109 in place. Netting 110 can be made of a variety of materials, such as plastic, rope, yarn, thread, or any fiber capable of being woven in a grid-like structure. Netting 110 can be held onto the base by use of at least one fastener to tack it down. Fastener can be, for example, a staple, tape, or adhesive.

In lieu of litter, a patch of grass or grass-like substance may be provided. In this instance, netting 110 may or may not be used.

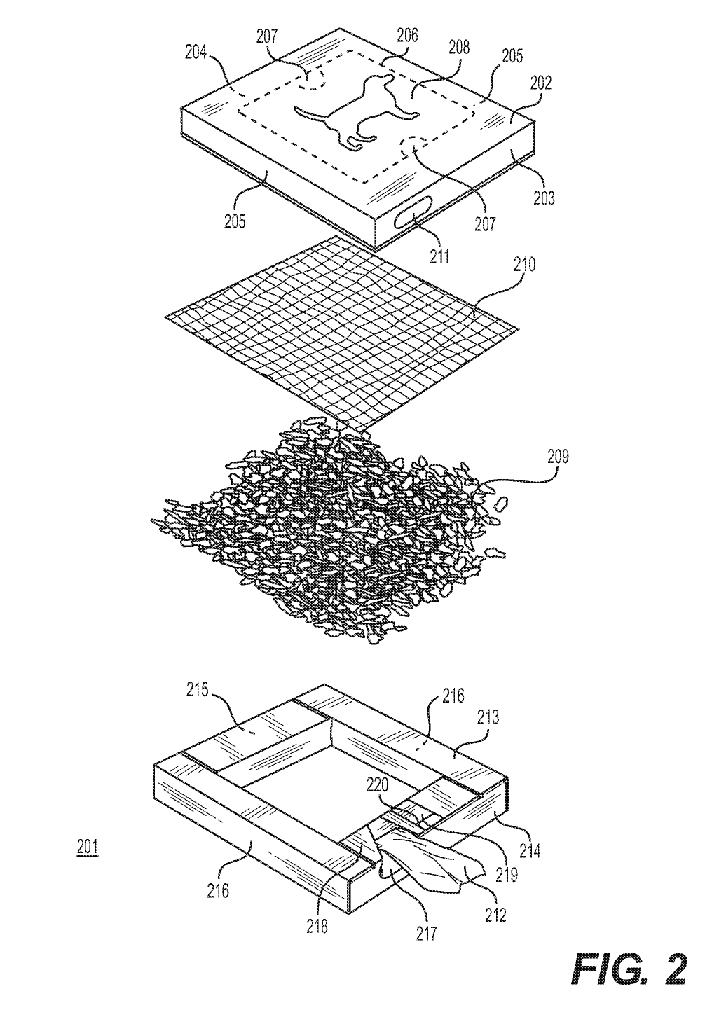

Provided on one of the walls (either front, rear or side) of the cover 102 is an opening 111 sized to allow a pet waste bag 112 to pass there through. Pet waste bags 112 often come in a roll with perforated edges between each bag to allow for tear-off of each bag. Edges of opening 111 can aid in easy tear-off at a perforated edge by the user. Details of the pet waste dispenser are shown in the exploded view shown in FIG. 2.

FIG. 2 illustrates pet waste system 201. As in FIG. 1, pet waste system 201 generally comprises a cover or lid 202 and base 213. Cover or lid 202 has a front wall 203, rear wall 204 and opposing sidewalls 205. The base has a front wall 214, rear wall 215 and opposing sidewalls 216 to mate with corresponding walls of the cover or lid 202. The cover or lid 202 can have a perforated edge 206 and at least one tab 207 to allow for removal of a portion 208 of the cover or lid 202 to expose the contents inside of the system 201.

Cover or lid 202 has opening 211 on a wall thereof to allow a pet waste bag 212 to pass there through.

Base 214 also has an opening 217 on one of its walls (in FIG. 2, on front wall 214, but it is understood it could be on any wall). Opening 217 extends through a top portion 218 of the base 214, which is sized to allow the pet waste bag 212 to be easily inserted and removed/replaced. As mentioned above, pet waste bags 212 often come in rolls with each bag separated by a perforated edge, wherein individual bags can be town off by a user. The edges of openings 217 and 211 facilitate tearing off one bag at a time.

Adjacent to opening 217, also in the top portion 218 of base 214 is a second opening 219. Second opening 219 can be created by folding down a section of top portion 218. Folded down portion 220 of top portion 218 aids in holding pet waste bag 212 in place by creating a side wall at 220 to prevent the pet waste bag 212 from sliding. Side wall at 220 is generally parallel to an opposing side wall which also aids in keeping the pet waste bag 212 in place. The side wall at 220 could be created by other means, and not necessarily by folding of a portion of the base. For example, a separate piece could be inserted to create side wall 220.

Base 213 generally holds litter 209. A netting 210 can be provided over the litter 209 to prevent the litter 209 from being kicked up by a pet using the pet waste receptacle. Details of the netting are published in U.S. Patent Publication 2016/0029589, incorporated herein by reference. In lieu of litter and/or netting, a patch or sheet of grass or other absorbent material can be provided in the receptacle.

Various types of materials can be used for the base and cover or lid of the pet waste system. For example, cardboard or any other biodegradable material can be used. Plastic materials can also be used. The receptacle can be a box or any other suitable container. The litter can also be used alone, i.e., without the box or container.

Instances in which a non water-resistant material is used for the base and/or cover or lid of the pet waste system, a water-resistant coating may be applied to portions of the pet waste system to prevent leakage through and breakdown of the receptacle. For example, wax has been found to work well as a coating to prevent liquid from permeating through the receptacle while being biodegradable itself. Other waterproofing materials, however, may be used and may be preferred over wax. A user may also supply his/her own base.

Holes (not shown in figures) can be placed in the cover or lid or base of the receptacle to provide ventilation. This may be desirable, for example, when the litter being used is a natural product requiring air flow. There can be any number of holes, but in one embodiment, 6-9 holes are provided and sized at 0.5 to 0.75 inches in diameter.

The receptacle and/or litter can be offered and/or mailed to and/or paid for by a user at regular and/or recurring intervals, for example, on a subscription basis. In the alternative, the litter can be delivered and/or paid for on a one-time basis. For example, the interval is variable, from days to years. This allows for a user to have fresh litter and/or receptacle at specified intervals, increasing convenience to the user.

The pet waste system of the present invention is not limited to particular examples provided above. For example, the litter can be organic or non-organic material. The litter can be shipped in the receptacle or alone to be used in a separate container. The delivery of the litter and/or receptacle can be recurring or can be delivered on a one-time basis. The receptacle may have holes or not, depending on the type of litter material. The receptacle may or may not have sides, as would be the case if shipped in a bag. Animals besides dogs and cats can use the receptacle. The receptacle can be waxed or otherwise waterproofed but need not be if the type of container is sufficient to do the job of containing the fluids without needing said waterproofing, for example, if the cardboard by virtue of its natural qualities works by itself. The receptacle can be likewise water resistance or not. The receptacle can be provided with or without a lid. The receptacle can be provided with or without a cover. The receptacle can be provided with or without a base.

In one embodiment, the user can be sent litter in any kind of bag or container. The user can be sent litter in any kind of bag or container which is simply replaced in a recurring way; a cadence could be, but is not limited to, weekly bi-weekly or monthly. The container it is shipped in can be designed to make it easy for the customer to give his/her dog access to the litter by being relatively flat and by having a top or lid to expose the litter for the dog to go to the bathroom on. The container can, in one embodiment, have a net that holds the litter in place to prevent it from exiting the container or bag.

Litter can be any material capable of absorbing urine or feces of an animal. The litter can be one of a variety of organic and inorganic materials, including, but not limited to, cellulose, plant fiber, wood chips, wood filings, bark, bark chips, wood shavings, moss, lichen, mulch, straw, potpourri, hay, dried grass, sawdust, wood pellets, sponge, sand, wildflower, any non-living grass or plant material such as peat, moss, fodder, coconut coir, gorilla hair, for example. Various combinations of these materials are also possible. Any other absorbent materials, capable of absorbing liquid, would also be suitable. For example, patches of grass would be suitable in conjunction with use along with the integrated pet waste bag receptacle.

An attractant can be used with the litter to encourage the dog to use the receptacle. The attractant can be synthetic or natural. The attractant can either be or simulate urine odor (or other odor to encourage the dog to use the litter). The attractant can be in the form of a spray, and it can be disposed in or on the litter or receptacle prior to shipping and delivery. The litter may also be soaked in the attractant prior to shipping and delivery. The attractant can also be shipped inside the receptacle in a separate container to be applied by the user. The attractant can also be delivered separately to be applied by the user. A separate attractant can allow the user to “activate” the litter upon receipt, increasing shelf stability.

The container can be any object capable of holding the litter. It can be made of any material, synthetic or natural, for example, cardboard, plastic, wood, etc. It can also be made of a biodegradable material. The container can be disposable. The container is generally the vessel in which the litter is held and can be used to ship the litter.

The receptacle can be any container capable of holding the litter. The receptacle can also be disposable.

The container and receptacle can be used together. For example, the container can be placed inside the receptacle so that the litter inside the container can be shipped inside the receptacle. The receptacle can be shipped with the litter alone without the litter being held in the container.

The litter, attractant, container and receptacle can be shipped/delivered all together, individually or in any combination. The delivery can occur as requested by the user or at specified intervals for automated delivery. Delivery can be recurring for one or all of the litter, attractant, container and receptacle. Automated delivery is also possible, along with automated payment for one or more or all of the litter, attractant, container and receptacle.

An absorbent layer can be included underneath the litter to absorb any waste that is not absorbed by the litter. This absorbent layer can be any number of materials, preferably a natural fiber that absorbs liquid well, such as cotton, gorilla hair or coconut coir.

While the foregoing written description of the invention enables one of ordinary skill in the art to make and use the invention, those of ordinary skill in the art will understand and appreciate the existence of variations, combination, and equivalents of the embodiments, methods, and examples provided herein. The invention should, therefore, not be limited by the embodiments and examples disclosed here, but by all embodiments and methods within the scope and spirit of the invention as claimed.

We claim:

1. A pet waste system with an integrated pet waste bag dispenser comprising:
a base comprising an absorbent material for absorbing pet waste;
an opening provided in said base; and
a pet waste bag provided in said opening.

2. The pet waste system of claim 1, wherein said pet waste bag is held within said opening.

3. The pet waste system of claim 2, wherein a side wall extends adjacent to said pet waste bag to hold said pet waste bag within said opening.

4. The pet waste system of claim 1, wherein the base comprises a fold-down portion, which fold-down portion holds said pet waste bag in said opening.

5. The pet waste system of claim 1, wherein the system further comprises a lid with an opening in a side wall of the lid to allow the pet waste bag to pass there though.

6. A pet waste system comprising:
a base containing an absorbent material for absorbing pet waste;
a lid designed to cover said base;
an opening provided in said base to accommodate a pet waste bag; and
an opening provided in said lid to allow said pet waste bag to pass through.

7. The pet waste system of claim 6, wherein the base comprises a fold-down portion, which fold-down portion holds said pet waste bag in said opening.
